(19) United States
(12) Patent Application Publication
(10) Pub. No.: US 2016/0104071 A1
(43) Pub. Date: Apr. 14, 2016

(54) SPATIO-TEMPORAL FORECASTING OF FUTURE RISK FROM PAST EVENTS

(71) Applicant: AxonAl, Inc., Harrisonburg, VA (US)

(72) Inventor: Sven A. Brueckner, Harrisonburg, VA (US)

(21) Appl. No.: 14/877,506

(22) Filed: Oct. 7, 2015

Related U.S. Application Data
(60) Provisional application No. 62/061,347, filed on Oct. 8, 2014.

(51) Int. Cl. G06N 5/04; G06N 7/00

(52) U.S. Cl. CPC G06N 5/04; G06N 7/005

(57) ABSTRACT

Computational processes and their associated data structures representing past events of interest in a geographic area and recent time period, contextual information such as terrain data, and labeled space-time probability fields are continuously executed to generate and update a spatial probability field that conveys the risk of similar such events occurring in the near future at given locations in the area of interest. The invention specifies two computational processes operating in shared data structures, one tracing back in time known past events to probable origin locations while accounting for movement constraints and location preferences, the other projecting event risk forward in time from likely origin locations, accounting for movement constraints and targeting preferences. The invention further specifies that these two processes may tune each others' parameters through the evaluation of the accuracy of the recall of past events, thus generating more accurate future event risk forecasts.

### REFERENCE TO RELATED APPLICATION

This application claims priority from U.S. Provisional Patent Application Ser. No. 62/061,347, filed Oct. 8, 2014, the entire content of which is incorporated herein by reference.

### FIELD OF THE INVENTION

This invention relates generally to information processing and, in particular, to a method of continuously generating and updating an estimate of the spatial probability across an area of interest for events to occur in the near future that are similar to a set of geospatially and temporally indexed events in the recent past in that area.

### BACKGROUND OF THE INVENTION

There are many scenarios where events of similar characteristics and cause continue to occur in a general geographic area of interest and where anticipating the location of such events in the near future would be beneficial. Examples of such event series in a security context are the emplacement of Improvised Explosive Devices (IED) by insurgents or the attacks on civilians by rebel fighters. In these and other cases, we may therefore assume that exists a hidden, goal-driven process that continues to generate the events constrained by the geographic and human terrain and the availability of resources and intelligence. That process is executed by spatially distributed individuals of whom we have only limited knowledge and whose actions we may only be able to observe as they result in the events they cause (e.g., attacks).

### SUMMARY OF THE INVENTION

The present invention offers the ability to combine various weak indicators and hypotheses, representations of objectives and constraints, and the locations, timing, and characteristics of recent past events into a continuously refined and updated spatial probability assessment for the occurrence of more such events in the near future. As a continuously executing computational process, new intelligence, new event data, and human operator suggestions are seamlessly integrated into the updated probability forecasts.

The invention continuously generates and updates an estimate of the spatial probability across an area of interest (e.g., a country in civil war) for events (e.g., attacks by rebel forces) to occur in the near future that are similar to a set of geospatially and temporally indexed events in the recent past in that area. The invention describes a collection of computational processes, methods and data structures that are combined in a given application to a specific choice of observed events, area of interest, and assumed constraints (e.g., anticipating future attack locations by rebel groups given their recently displayed motivations, capabilities, and attack patterns). A key novelty of this invention is that the parameters of the computational processes are continuously optimized to accurately replicate the pattern of recent events and thereby maximize the confidence in the event probability distribution generated for the near future.

The computational processes and their data structures embodying this invention are executed by one or many processors on a single or a collection of hardware platforms. Any memory maintained by these processes (e.g., probability fields) is presumed to be computer memory (e.g., Random Access Memory (RAM), processor cache, (temporary) files stored on internal or external hard disks, databases). The location of any real-world entity or event represented in the data structures may but does not need to correspond to the physical arrangement of the hardware platforms that execute the computational processes.

### BRIEF DESCRIPTION OF THE DRAWINGS

FIG. 1 illustrates our assumption that for any observed event there are unknown origin locations with paths from origin to event location that are constrained by geographic features and movement preferences;

FIG. 2 shows relevant geographic attributes in the lat/lon area of interest are represented as a temporal markup in a gridded 2D array;

FIG. 3 highlights that events of interest populate discrete (lat/lon/time) locations in a space-time volume spanned over the area of interest from the current time (“now”) back to the chosen “hindcast horizon”. The forecast of risk for future events of similar kinds occupies a 2D grid adjacent to the space-time volume that can be considered a one-unit extension of the hindcast-horizon-to-now volume;

FIG. 4 depicts that for each event concurrently, we trace the possible origins back through space and time, accounting for any mobility constraints and location/traversal preferences the instigators of the event may have had in reaching the event site. This hindcast process reasons back in time and across space, starting with discrete space-time locations (events) and creating spatial “event origin” probability distributions for any point in time between “now” and the model's hindcast horizon;

FIG. 5 reinforces the fact that the spatial “event origin” field at any given point in time may be refined through additional atemporal (across space but for fixed time) reasoning processes; p FIG. 6 visualizes that for any discrete point in space-time with a non-zero probability to be the origin of events later in time, we project forward how instigators of events originating from that location would have moved (constrained and preferentially) to reach potential event sites. At space-time locations that are suitable for such events (e.g., taking civilian hostages requires the presence of civilians, for instance in a village), the reasoning process marks up resulting “event risk” that is normalized across space for discrete points in time;

FIG. 7 emphasizes that just as with the emerging “event origin” probability field (FIG. 5), spatial “event risk” probabilities at any fixed point in time may be refined with atemporal reasoning processes;

FIG. 8 illustrates that the “near future” array is a one-unit extension of the space-time volume reaching from the hindcast horizon to “now”. The forecasting process(es) that create(s) the “event risk” probability fields for points in time in that volume also extend(s) into the “near future” time to create the desired risk forecast that is the product of the overall model;

FIG. 9 depicts a data flow schema: From past events, hindcast creates a spatio-temporal “event origin” estimate that may be refined by additional atemporal reasoning processes. From this field, forecasting (and further atemporal refinement) creates an “event risk” field in the same volume, but that is also expanded one step further into the near future;

FIG. 10 expands FIG. 9 with an additional source of change of intermediate products: a machine learning process that drives the model to minimize the delta between the forecast of event risk for times in the past and the actual occurrence of such events at that time. With such reinforcement learning, the model continuously self-tunes its hindcasting and forecasting processes to reproduce the known past. As these processes also produce the forecast of event risk the near future, self-tuning to the past increases the accuracy of the forecast into the future;

FIG. 11 summarizes the key elements of a polyagent model: avatar agents that continuously create ghost agents who execute their simple behavior in a shared model environment but expire quickly;

FIG. 12 suggests that a method to realize the hindcasting process from event occurrences to “event origin” probability estimates is based on a polyagent model. For each event, we set up a single avatar who continuously creates “tracer ghost” agents at the space-time location of the event. These ghosts simulate (in reverse) the possible movement of the perpetrators of the event in space (geographic movement constraints and preferences) and (backwards) time. As locations that they encounter match origin requirements for the type of event represented by the ghosts' avatar, the “tracer ghosts” mark them up with contributions to the “event origin” field. A normalization of the “event origin” contributions across space for any fixed point in time yields the desired probability contribution;

FIG. 13 shows how tracer ghosts reverse the likely trajectory of an entity that participated in the event the ghost's avatar represents;

FIG. 14 points out that polyagents also offer a method for realizing the continuous projection of “event origin” forward in time into “event risk”. Here we take advantage of the discretization of geographic space and time, by assigning each such unit volume a single avatar. That “cell” avatar creates “projector ghost” agents at a rate proportional to the “event origin” probability at that space-time location. These “projector” ghosts move forward in time while sampling the movement constraints and preferences of the postulated perpetrators of the events whose origin was postulated for the avatar's cell, thereby exploring possible perpetrator trajectories from event origin to event site. At locations that meet the requirements to be an event site, the “projector” ghosts contribute to the local “event risk” field. A normalization of that field across space for fixed time yields the “event risk” probability; and

FIG. 15 introduces a method for realizing a reinforcement learning process that minimizes the delta between the “event risk” estimated for a given point in time in the past and the actual occurrence of events. The “projector ghost” instances build up an internal measure of “confidence” that is increased in each step inversely proportional to the distance of the ghost to actual events that have similar characteristics. Thus, ghosts are rewarded for replicating (with minimum divergence) actual events. The behavioral model that drives the spatial movement of the ghosts is parameterized where the parameters for a given ghost are drawn from a probability distribution. Ghosts, whose behavioral parameters led to a high “confidence” value reinforce the likelihood that those parameters are chosen again for future ghosts while low “confidence” values lower the selection probabilities for those ghosts' parameters.

### DETAILED DESCRIPTION OF THE INVENTION

Before proceeding with a more detailed description of the system and method, the following Objectives, Declarations and Assumptions are made:

Objective: For a set of geospatially and temporally indexed events in the recent past in an area of interest, we estimate the spatial probability across that area for similar events to occur again in the near future.

Declaration: Each event is defined at a minimum by its geospatial coordinates (e.g., latitude and longitude) and the time of its occurrence. In addition, an event may be characterized further by a scalar measure of magnitude and other descriptors (e.g., labels).

Declaration: The set of events in the area of interest may be growing over time, in which case, the estimate of event risk shall also evolve to account for new events.

Assumption: We only consider events for which we can assume that they were caused by entities that had to move from one or more origin locations to the event location.

Assumption: We assume further that the movement of these entities is constrained by geographic features (e.g., rivers, roads, mountains) and influenced by movement preferences (e.g., avoid check-points).

Assumption: Optionally, there may be geographic features that influence the suitability of any given location as an origin or destination of the assumed entities.

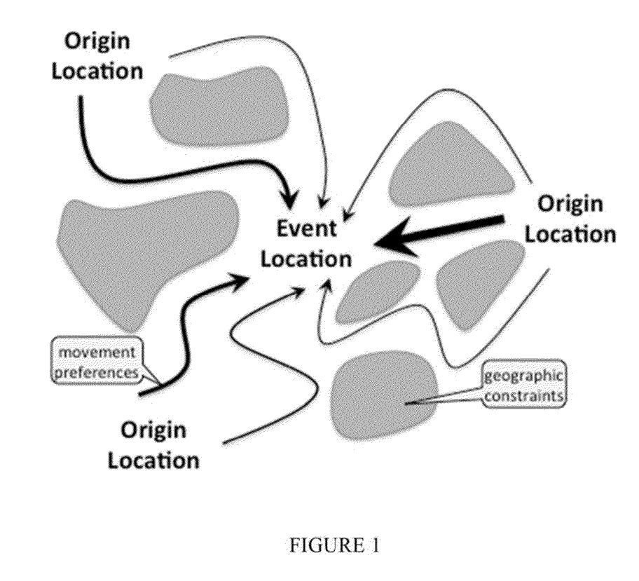

FIG. 1 illustrates the assumptions.

We generate an estimate of the spatial probability of the occurrence of new events in the near future by first tracing the previous events to their possible origins and then projecting event risk from those assumed origins.

The tracing back and projecting forward may be accomplished by various methods. We assume that any such method constructs at least two sets of time-indexed spatial distributions:
1) “event origin”—the likelihood, for any given point in time in the past, that a given geographic location is the origin for one or more future event.
2) “event risk”—the likelihood, for any given point in time in the past or near future, that at a given geographic location an event may occur.

Examples of methods for creating these probability distributions may be constructive simulations of the entities' geographic movement or the constrained propagation of units of probability through space and time.

A simple instantiation of the postulated reasoning approach is presented in [1] where the events are instances of emplacement of Improvised Explosive Devices (IED) at locations in an urban terrain. But the solution does not track probabilities at distinct points in time (only spatial reasoning) nor does it account for differences in the characteristics of specific events.

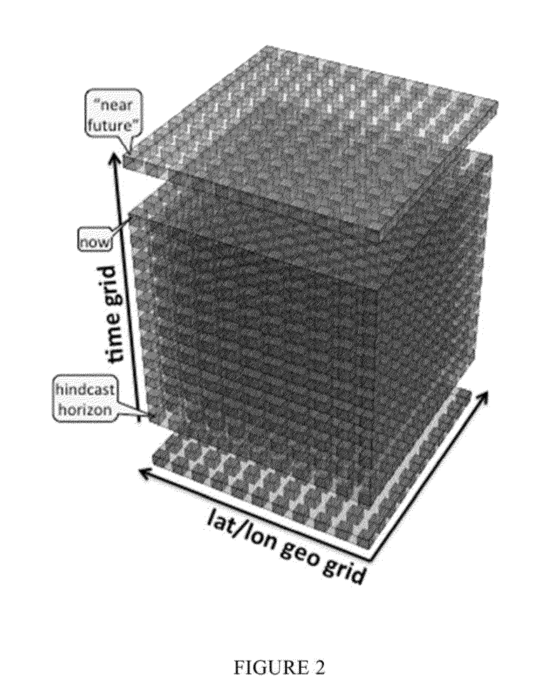

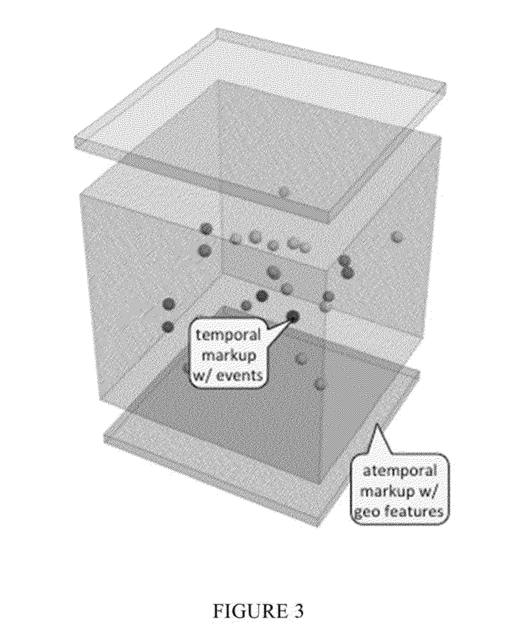

FIGS. 2 and 3 illustrate the key knowledge representations in our solution. We distinguish between an atemporal representation of available geographic features (2D area at the bottom), the time-indexed collection of probability distributions over the area of interest (3D volume in the middle) within which we also find the relevant past events, and the spatial probability distribution(s) in the “near future” (2D area at the top). Depending on the specific realization of the reasoning process, spatial and temporal indexing may be discrete (collection of “cells” on the left) or continuous (2D and 3D volumes on the right).

In the following, we first discuss the key processes that result in the desired event risk forecast from past events. Then we offer a specific example of how these processes may be realized.

### Process Flow—Hindcast

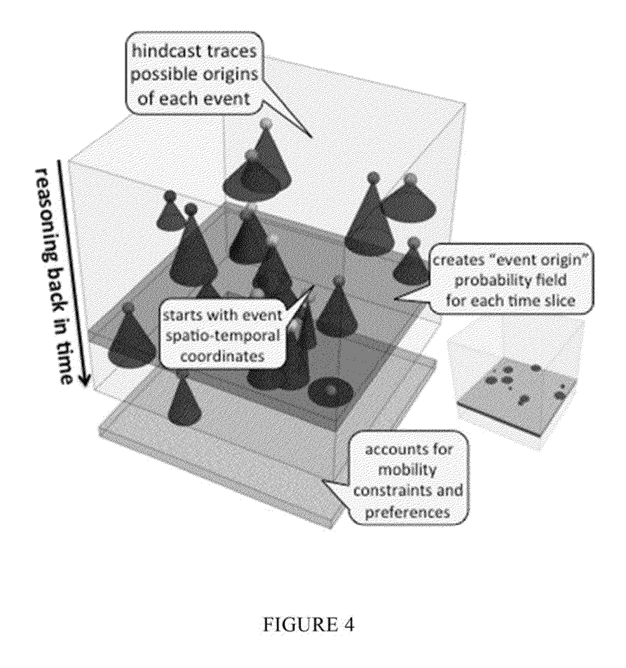

FIG. 4 illustrates the process of tracing back (hindcasting) the perpetrators of events to their origins. For each event at its respective spatio-temporal coordinates (e.g., latitude, longitude, time), we are tracking possible space-time trajectories that terminate at the event (blue cones) and that adhere to the mobility constraints and preferences postulated for the event perpetrators. For any time index (horizontal slice through the space-time volume), we mark locations traversed by any of these trajectories for any event with “event origin” contributions. These contributions may be modulated (e.g., weighed) by various factors, such as the numbers of events for which trajectories traverse the location, the portion of trajectories for a single event that traverses that location at the given time, or various measures of confidence in the correctness of the trajectory estimate.

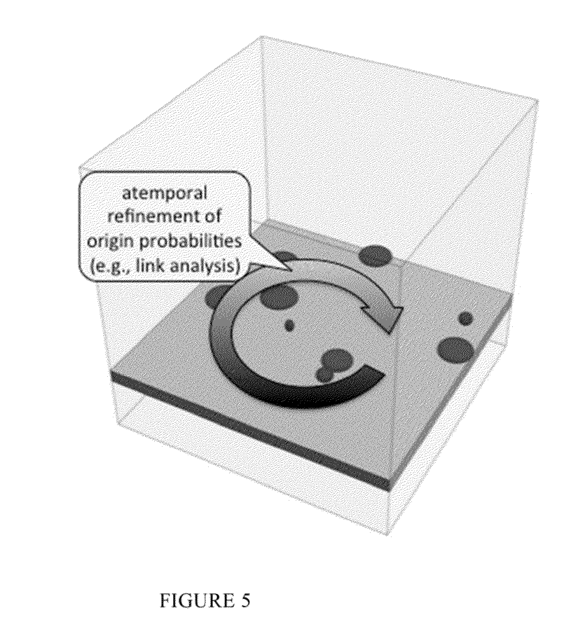

Normalizing all such contributions at a given point in time across the area of interest creates the “event origin” probability distribution. As illustrated in FIG. 5, normalization is only one of many possible atemporal reasoning processes that may operate on the “event origin” spatial distributions created by the hindcasting process. Such atemporal processes include indiscriminate sharpening of the spatial probability distribution for reduction in entropy, or link analysis for events of common origin by common characteristics.

### Process Flow—Forecast

As stated previously, the event risk forecasting process projects event origin estimates forward in time and across space. Thus, as illustrated in FIG. 6, any non-zero event origin probability at any point in time in the volume of interest (circles) is considered a possible event origin and thus becomes the source of possible trajectories (cones). As with the hindcasting process, the “event risk” probability field (for each time index) is established by the contributions from all trajectories to the space-time locations they traverse.

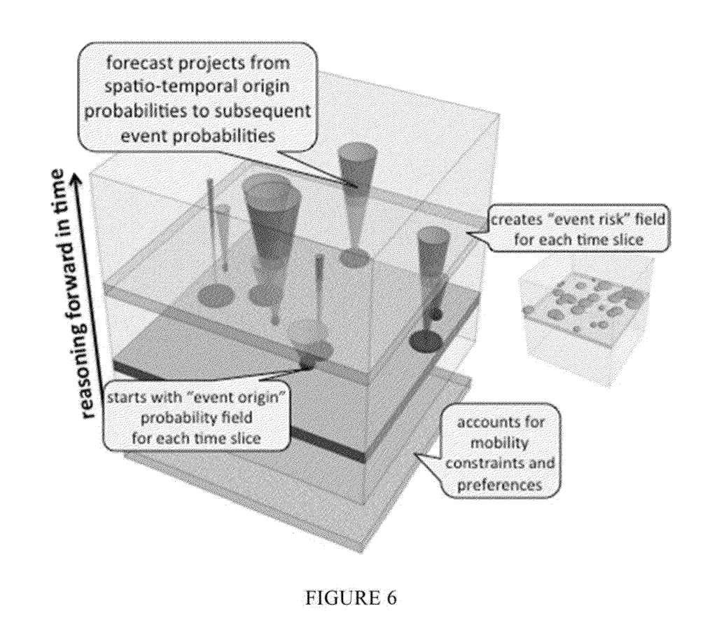

The resulting “event risk” probability fields across space for fixed time indices may also be refined by atemporal reasoning processes (FIG. 7). For example, they may be modulated for the actual occurrence of events as the “event risk” distribution in the past describes those events that could have been.

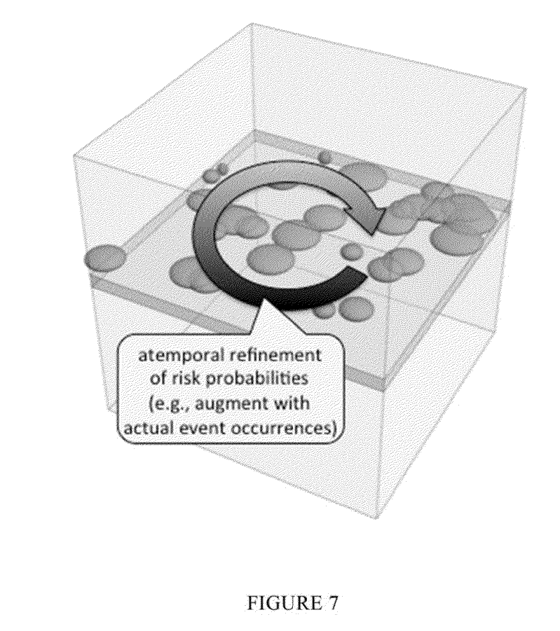

While the event hindcasting to possible origin locations operates, by obvious necessity, solely over time indices that are in the past, the event risk forecasting process expands beyond now into the near future. As a result (FIG. 8), our spatial “event risk” probability field marked as “near future” is populated from “event origin” hypotheses in the recent past, thereby creating the forecast product desired in the initially stated objective.

### Process Flow—Summary

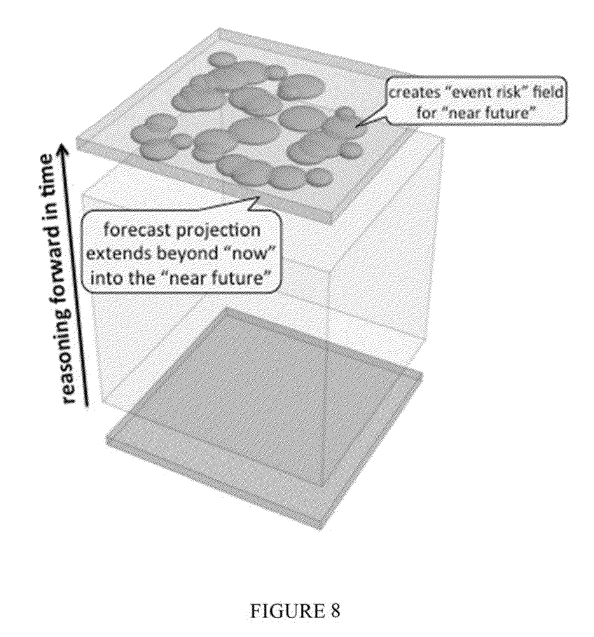

FIG. 9 summarizes the key representations and reasoning processes of the event-risk forecasting model:
1) We consider a set of recent events located in the space-time volume of interest.
2) From these events, a hindcasting process traces the possible movement of event perpetrators back from event locations to estimated origin locations, taking account of movement constraints and preferences.
3) The hindcast establishes a spatio-temporal “event origin” probability field. That field spans the past temporal volume over the area of interest from the model's hindcast horizon to the model's index of “now”.
4) Additional, atemporal reasoning processes may refine the “event origin” field.
5) From the “event origin” field, a forecasting process traces the possible movement of event perpetrators forward from estimated event origins to forecast event risk locations, taking account of movement constraints and preferences.
6) The forecast establishes a spatio-temporal “event risk” probability field. That field spans the entire temporal volume over the area of interest from the model's hindcast horizon, through “now”, to the “near future” distribution.
7) Additional, atemporal reasoning processes may refine the “event risk” field.
8) The “event risk” spatial distribution temporally indexed as “near future” is the final product of the forecasting model.

Without loss of generality, we assume that the aforementioned hindcast, refinement, and forecast processes operate continually and concurrently, affecting each other through their shared data products and parameters.

The need for such concurrent repeated computation of the same data products is not yet readily apparent in FIG. 8, where the processes could conceivably execute in sequence (hindcast, “event origin” refinement, forecast, “event risk” refinement) that is repeated every time a new event is added to the set or the time window of interest shifts forward (real-world time passes and “now” moves forward). But, as shown in FIG. 9, concurrent recalculation al-lows us to easily introduce additional feedback processes that tunes hindcast and forecast of event risk to the actual pattern of event occurrences.

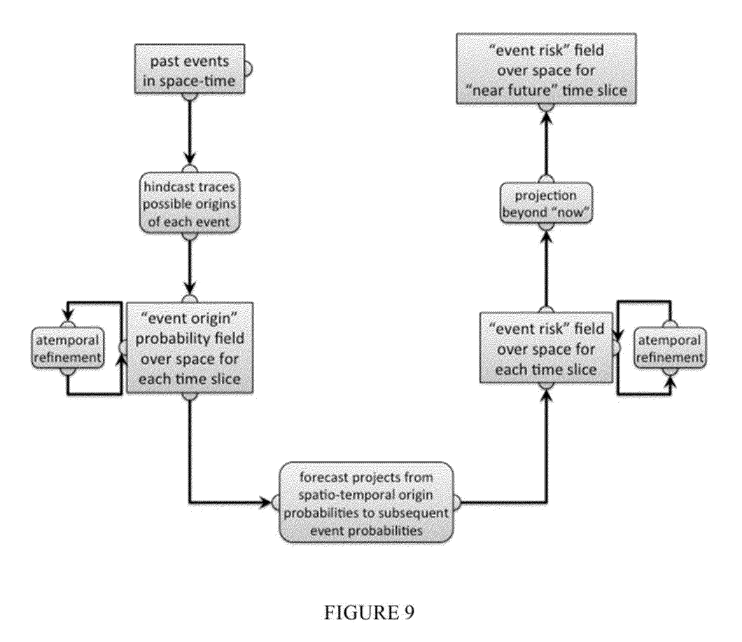

As stated in the initial assumptions, our hindcast and forecast processes are seeking to replicate the movement of unknown entities (from unknown origin to known event sites) whose existence, motives, and constraints we only postulate as a construct to aid the reasoning processes. Therefore it is reasonable to assume that any model that emulates those entities' movement in hindcast or forecast will be highly parameterized (e.g., parameters weighing the relative importance of movement preferences, or parameters affecting entity mobility such as speed on a given terrain). Any valid choice of parameters may produce a different event risk forecast pattern. Shown in the center of FIG. 10, we add a feedback process that guides the hindcast/forecast processes towards parameters that result in “event risk” fields that match the actual occurrences of events. The better these processes replicate the past, the more confident can we be in their prediction of the near future.

Implementation with Polyagents

In the following, we discuss a possible realization of the desired process flow with a polyagent model. Polyagent models are complex, hierarchical, multi-agent models that, in general, perform self-tuning constructive simulations of entities embedded in a structured environment. For an introduction to polyagents, refer to [2] or [3] for instance.

Any polyagent model has two key elements: a population of persistent “avatar” agents, each associated with a population of ephemeral “ghost” agents. The term “agent” refers to the fact that any avatar or ghost may be considered an autonomously executing software thread with a volatile internal state and a set of behavioral rules that are conditioned on that state and (simulated) sensor stimuli.

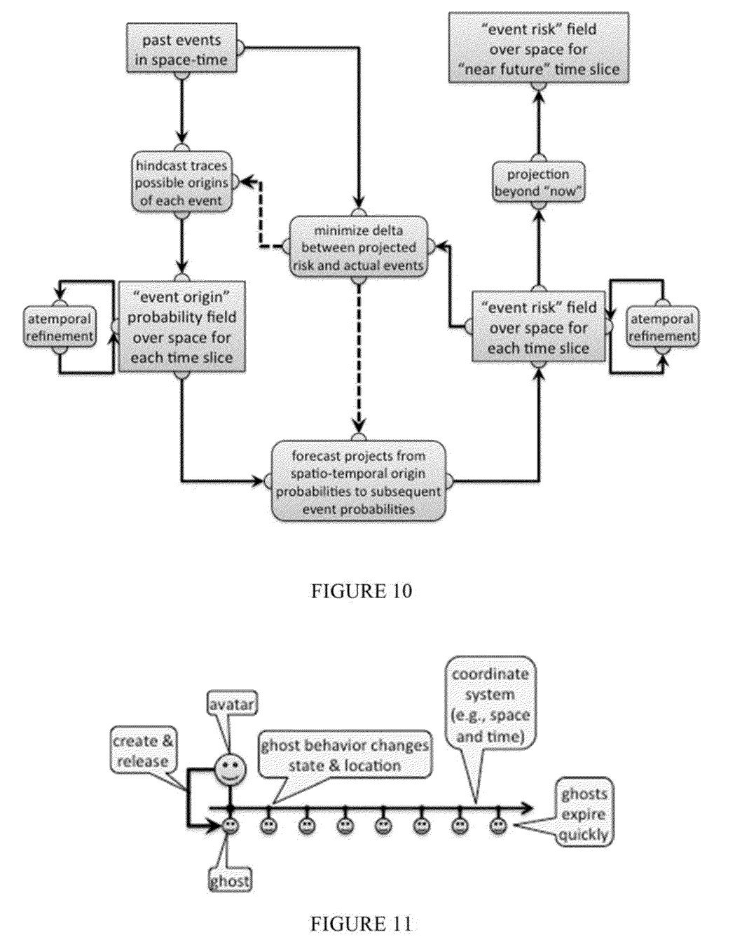

Avatars typically have a one-to-one mapping to unique entities in the domain of interest. Their primary role is that of a manager of a population of ghosts, where each ghost is a short-lived probabilistic emulation of a possible activity sequence of the domain entity that the avatar represents. The avatar continuously creates new ghosts and releases them into the model where they execute for a short time and then expire (FIG. 11).

Realization with Polyagents—Hindcast

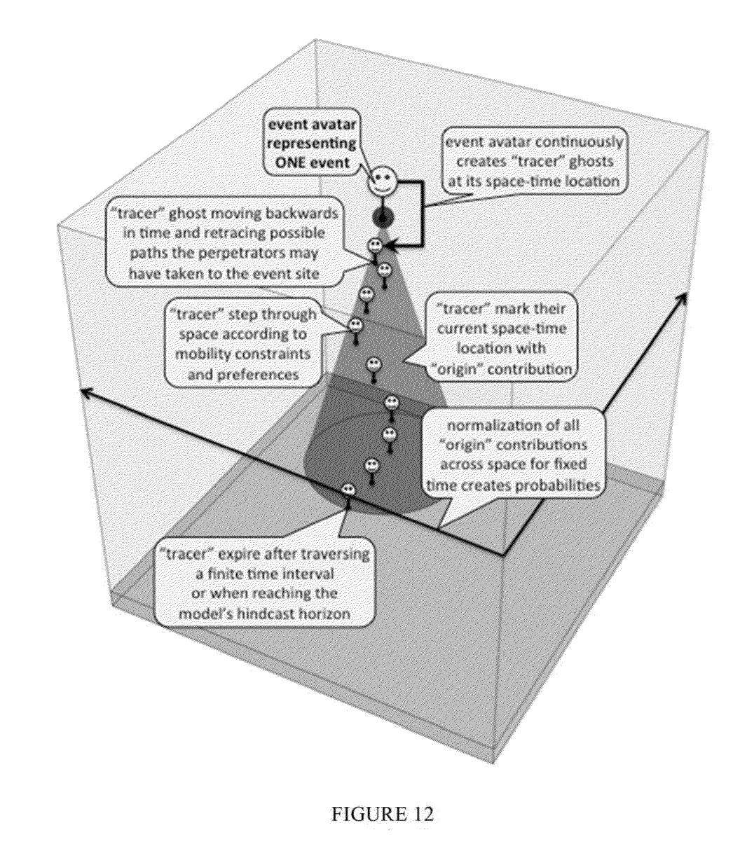

FIG. 12 shows a possible realization of the hindcasting process with polyagents. Here we associate each past event with a single polyagent (one “event” avatar and a population of “tracer” ghosts). The avatar shares the space-time coordinates of the event. It continuously creates “tracer” ghosts and places them at the geographic and temporal location of the event in our model representation. If the event is further characterized with any attributes besides its space-time coordinates, the ghosts inherit those attributes.

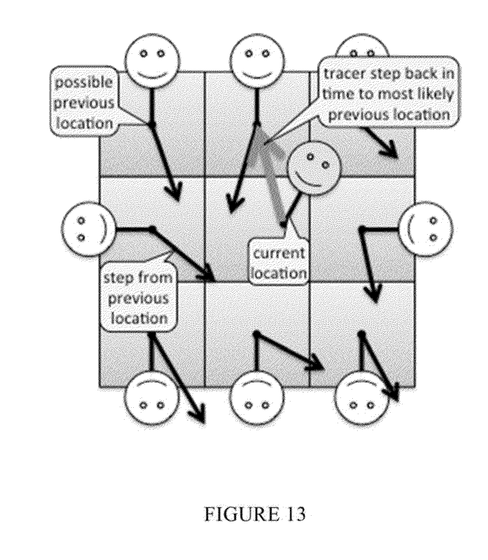

Each tracer ghost's role is to emulate a single trajectory that the postulated entities may have taken from an origin location to the event location under movement constraints and preferences. Since the origin is unknown, we start the tracer at the event location and execute its moves backwards in space and time. In each step from its respective current spatial location, the tracer ghost picks a new location in its neighborhood that would have had the highest likelihood of having been the origin of that step to the current location. That likelihood is determined, for instance, by applying all constraints and preferences from all neighboring locations (FIG. 13).

As the tracer ghosts move through space and back in time, they assess the geographic features of the locations they visit against any desired characteristics of origin locations. If there is a significant match, or if no such criteria are specified, the tracer ghost will mark that space-time location (cell in volume in FIG. 2) with an additive contribution to the “event origin” field. If the ghost carries additional event attributes inherited from the event avatar, it may also contribute to specialized “event origin” sub-fields that are labeled with these attributes. For more details on field markup by agents, refer to digital pheromone fields discussed, for instance, in [4]. Appropriately normalized, the “event origin” contributions of all tracer ghosts from all event poly-agents form the desired spatial probability distributions indexed for discrete time intervals.

Tracer ghosts continue to move back in time until they either pass the model's overall hindcast horizon or the ghost reaches its internal limit on steps to be executed.

Realization with Polyagents—Forecast

Realizing the forecasting process with polyagents requires that we emit “projector” ghosts from any space-time location that is estimated to be a possible origin for any of our events. These projector ghosts then emulate the movement of the perpetrating entities from that origin to possible event locations while adhering to movement constraints and preferences. If the “event origin” field has sub-fields for specific event attributes, then projector ghosts carry those forward proportionally to the intensity of those attributes in the “event origin” field.

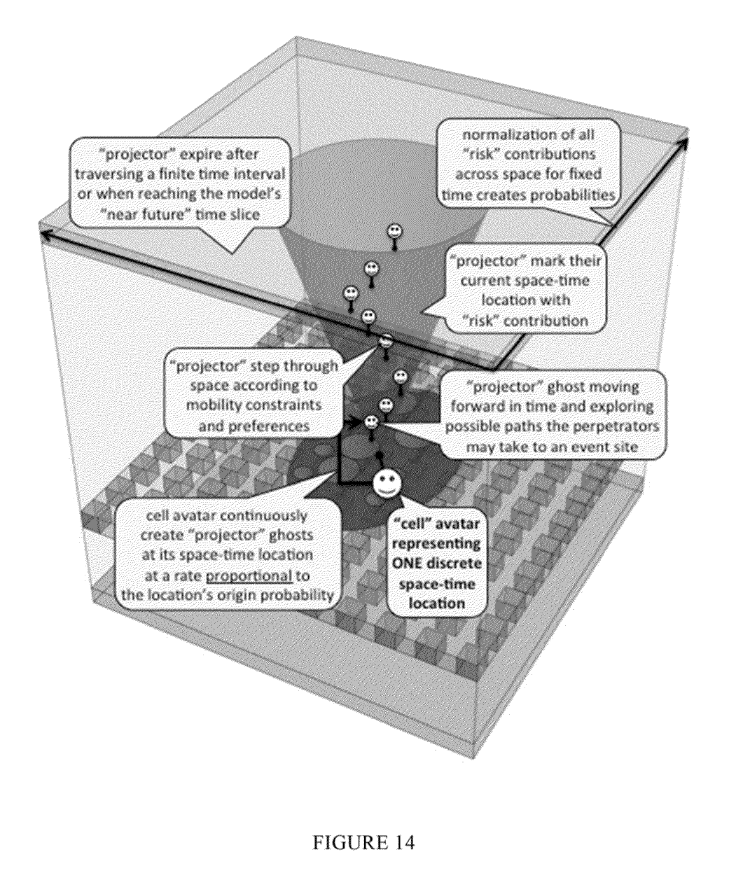

FIG. 14 illustrates a possible realization. Each discrete cell in our model's space-time volume (FIG. 2) is associated with a “cell” avatar. The avatar creates projector ghosts at a rate proportional to the cell's current event origin probability estimate. Thus avatars for cells that currently are not considered likely origins of events are contributing significantly fewer trajectory samples to the overall event risk forecasting than those locations that are likely origins.

Each projector ghost emulates the movement of a perpetrator entity through space and forward in time. Thus, the ghost executes the same logic once per step that the “tracer” ghost had to apply multiple times per step to decide where the entity came from (FIG. 13).

As the projector ghosts move through space and forward in time, they assess the geographic features of the locations they visit against any desired characteristics of event locations. If there is a significant match, or if no such criteria are specified, the projector ghost will mark that space-time location (cell in volume in FIG. 2) with an additive contribution to the “event risk” field. If the ghost carries additional event attributes inherited from the event origin sub-fields, it may also contribute to specialized “event risk” sub-fields that are labeled with these at-tributes. Appropriately normalized, the “event risk” contributions of all projector ghosts from all cell polyagents form the desired spatial probability distributions indexed for discrete time intervals.

Projector ghosts continue to move forward in time until they either contribute to the model's near-future spatial event risk probability distribution or the ghost reaches its internal limit on steps to be executed.

Realization with Polyagents—Self-Tuning with Reinforcement Learning

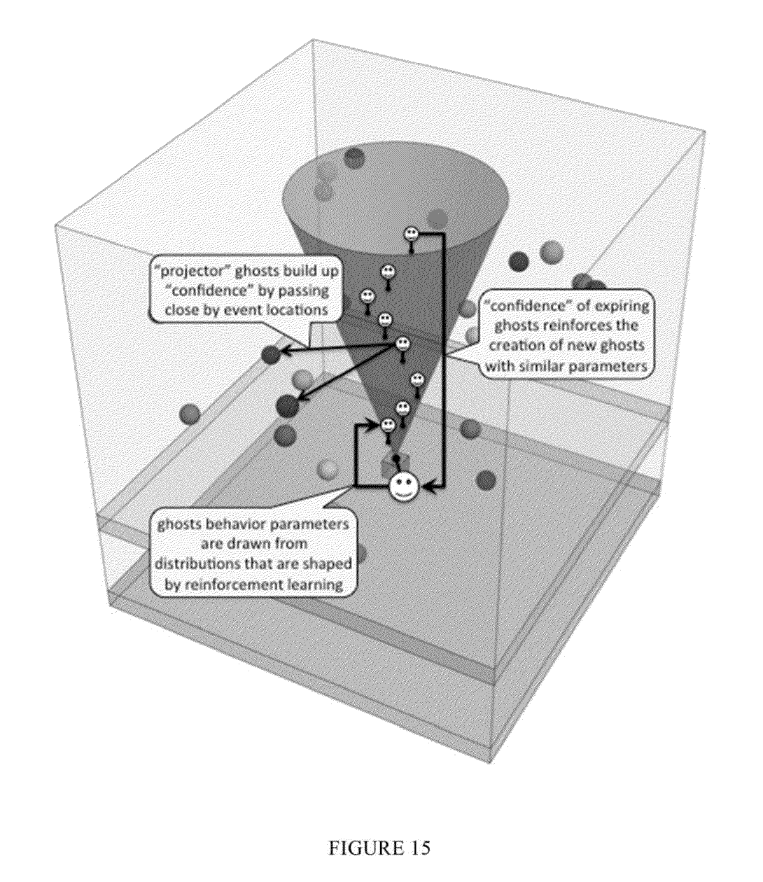

In FIG. 10 we introduced the concept of tuning the parameters of the hindcast and forecast model based on the difference between the resulting “event risk” field for time indices in the past and the actual occurrence of events. In FIG. 15, we show how such tuning may be achieved in the polyagent model.

Cell avatars create projector ghosts with specific behavioral parameters that influence their movement decisions and thus the trajectories they explore. Assume that each such parameter setting for a single ghost is selected by sampling a probability distribution over all valid parameter values.

As the projector ghost moves through space and time, it measures its distance to actual events and contributes to an internal measure of “confidence” amounts that are inversely proportional to that distance. Thus, projector ghosts, whose movement decisions lead them closer to actual events build up more confidence than those that do not reach these events.

At the end of its execution, the projector ghost reports back to its avatar its parameter set-tings and the level of confidence it has accumulated. The avatar, in turn, modifies the probability distributions over valid parameter values such that values that resulted in higher ghost confidence have an increasingly higher likelihood of being selected in the creation of subsequent projector ghosts. Thus, we are creating an evolutionary process that selects for ghost parameters that best replicate the past events.

Not shown in the figure is the fact that the ghosts' confidence values may also modulate the near-future event risk probability field as the contribution by the projector ghosts there (but only there) may be multiplied by the ghost's confidence value to emphasize those locations that are reached with high confidence.

As projector ghosts and tracer ghosts share the same process for determining the next perpetrator move forward in time (only that the tracer reverses that step), cell avatars may share their successful ghost parameter selection distributions with nearby event avatars so that these well-tuned parameters are also used in the hindcasting process.

### REFERENCES

### [1] S. Brueckner, S. Brophy, and E. Downs, “Swarming Pattern Analysis to Identify IED Threat,” in Self-Adaptive and Self-Organizing Systems (SASO), 2010 4th IEEE International Conference on, 2010, pp. 271-272.

[2] H. V. D. Parunak and S. Brueckner, “Concurrent modeling of alternative worlds with polyagents,” in Multi-Agent-Based Simulation VII, Springer, 2007, pp. 128-141.
[3] H. V. D. Parunak, S. Brueckner, D. Weyns, T. Holvoet, P. Verstraete, and P. Valckenaers, “E pluribus unum: Polyagent and delegate mas architectures,” in Multi-Agent-Based Simulation VIII, Springer, 2008, pp. 36-51.
[4] S. Brueckner, Return from the Ant. Berlin, Germany: Humboldt University, 2000.

1. A method of forecasting future risk from past events, comprising the steps of:
receiving and storing, in a computer memory, information regarding one or more previous events that occurred in a region of interest, the information including the spatio-temporal coordinates of each event;
providing a computer programmed to access the memory and automatically perform a hindcasting process wherein the previous events are traced through a first set of time-indexed spatial probability distributions to determine possible geospatial and temporal origins of the previous events; and
automatically performing a forecasting process by projecting, from the possible origins of the previous events through space and time, a second set of time-indexed spatial probability distributions to determine whether an event similar to one or more of the previous events will occur in the region.

2. The method of claim 1, wherein each event is defined by latitude and longitude coordinates and the time of occurrence.

3. The method of claim 1, wherein the region of interest is a geographical area and the event involve human actions or interactions.

4. The method of claim 1, wherein the spatial probabilities associated with one or both of the hindcasting and forecasting processes take into account constraints or preferences.

5. The method of claim 1, wherein the first and second sets of time-indexed spatial probability distributions form virtual cones in a spatio-temporal volume.

6. The method of claim 1, including the step of characterizing an event by a scalar measure of magnitude and other descriptors (e.g., labels).

7. The method of claim 1, wherein, if events in an area of interest are growing over time, the estimate of event risk also evolves to account for new events.

8. The method of claim 1, wherein:
the first set of time-indexed spatial distributions includes the likelihood, for any given point in time in the past, that a given geographic location is the origin for one or more future events, and
the second set of time-indexed spatial distributions includes the likelihood, for any given point in time in the past or near future, that an event may occur at that geographic location.

9. The method of claim 8, wherein the distributions are constructive simulations of an entity's geographic movement.

10. The method of claim 8, wherein the distributions represent the constrained propagation of units of probability through space and time.

11. The method of claim 1, wherein:
the hindcasting process traces the possible movements of event perpetrators back from event locations to estimated origin locations to establish a spatio-temporal “event origin” probability field over the area of interest from a hindcast horizon to an index of “now”;
the forecasting process traces, from the “event origin” probability field, the possible movements of the event perpetrators forward from estimated event origins to forecast event risk locations to establish a spatio-temporal “event risk” probability field that spans the entire temporal volume over the area of interest from the hindcast horizon, through the present time, to a “near future” distribution; and
wherein the process outputs the “event risk” spatial distribution temporally indexed as the “near future” distribution.

12. The method of claim 11, wherein both the hindcasting and forecasting processes take perpetrator movement preferences or constraints into account.

13. The method of claim 11, including the step of using one or more atemporal reasoning processes to refine the “event origin” field.

14. The method of claim 11, including the step of using one or more atemporal reasoning processes to refine the “event risk” field.

15. The method of claim 1, wherein the hindcasting and forecasting processes are continuously optimized to accurately replicate the pattern of recent events and thereby maximize the confidence in the event probability distribution generated for the near future.

16. The method of claim 1, including the step of defining a polyagent model with a plurality of agents, each agent being implemented as an autonomously executing software thread with a changeable internal state and a set of behavioral rules conditioned on that state, including a population of persistent avatar agents that manage a population of short-lived ghost agents; and wherein:
each past event is represented by an event avatar that continuously creates and places tracer ghosts at the geographic and temporal location of the event;
as part of the hindcasting process, each tracer ghost moves back in time, emulating a single trajectory that perpetrating entity may have taken from an origin location to the event location; and
as part of the forecasting process, projector ghosts from any possible event origin emulate the movements of the perpetrating entities from that origin to possible event locations.

17. The method of claim 16, wherein movements emulated by the tracer and projector ghosts adhere to movement constraints and preferences.

18. The method of claim 16, wherein the tracer ghosts begin at the event location and move backwards in space and time.

19. The method of claim 16 wherein, from each respective current spatial location, each tracer ghost moves through space and back in time by picking a new location in its neighborhood that would have had the highest likelihood of having been the origin of that step to the current location.

20. The method of claim 19, wherein the highest likelihood is determined by applying all constraints and preferences from all neighboring locations.

21. The method of claim 16 wherein:
as each projector ghost moves through space and forward time, it measures its distance to actual events and contributes to an internal measure of “confidence” amounts that are inversely proportional to that distance; and
at the end of its execution, each projector ghost reports back to its avatar its parameter settings and the level of confidence it has accumulated.

22. The method of claim 21, wherein the avatar modifies the probability distributions over valid parameter values such that values that resulted in higher ghost confidence have an increasingly higher likelihood of being selected in the creation of subsequent projector ghosts.

23. The method of claim 16 wherein, if a tracer or projector ghost carries additional event attributes inherited from the event avatar, that ghost may contribute to specialized “event origin” sub-fields that are labeled with these attributes.
